(19) United States
(12) Patent Application Publication
(10) Pub. No.: US 2026/0003153 A1
(43) Pub. Date: Jan. 1, 2026

(54) SEAL FOR OPTICAL ELEMENTS

(71) Applicant: II-VI Delaware, Inc., Wilmington, DE (US)

(72) Inventor: Gunnar Koehler, Wilmington, DE (US)

(21) Appl. No.: 18/955,518

(22) Filed: Nov. 21, 2024

(30) Foreign Application Priority Data
Jun. 26, 2024 (DE) 10 2024 118 099.4

(51) Int. Cl. G02B 7/00; G02B 7/02; G02B 7/182

(52) U.S. Cl. CPC G02B 7/007; G02B 7/02; G02B 7/182

(57) ABSTRACT

The present disclosure relates to a holder and a method of using an optical element, where the holder comprises a drawer having a base plate having an opening above which a seat is arranged in which an optical element is arranged, wherein a seal is arranged between a lower edge of the optical element and an inner lower end of the opening of the base plate of the drawer and a pressure ring is arranged around the seat, which has at least one projection on its underside which engages in at least one recess on the upper side of the base plate, and where the bottom of the at least one recess has a ramp with a seamlessly changing height in relation to an underside of the base plate. A laser processing head for laser material processing comprises at least one holder as described above.

### CROSS-REFERENCE TO RELATED APPLICATIONS

The present invention claims priority to national German patent application no. DE 10 2024 118 099.4 filed on Jun. 26, 2024. The aforementioned application is hereby incorporated herein by reference in its entirety.

### FIELD OF THE DISCLOSURE

The present disclosure relates generally to a seal for optical elements.

### BACKGROUND OF THE DISCLOSURE

Lasers, laser processing heads and systems, components and accessories for these as well as laser measuring instruments are generally known in the art. The laser processing heads and systems are designed for processing materials, including welding, soldering and cutting.

Laser processing heads and systems comprise a large number of optical elements. For beam shaping, laser processing systems use lenses, for example, which collimate or focus the laser beam. The optical elements are usually arranged in groups along the optical axis and are combined in so-called tubes. Entire groups of optical elements can often be exchanged as required, rather than having to replace many individual elements.

When workpieces are welded and cut, emissions occur which can be deposited in the vicinity of the processing area and thus lead to a reduction in the function of laser optics due to deposits on the optical surfaces. These deposits not only limit the performance of the optical systems but can also damage or even destroy the laser optics. In laser processing heads, it may also be necessary for optical elements to be sealed pressure-tight on at least one side, as there is high pressure on one side of an optical element. For this reason, the optical elements of such devices are sealed pressure-tight on one side.

Laser processing heads for laser applications with a wavelength of 1 μm usually consist of one or more lenses and one or more protective glasses to prevent contamination of the lenses. This may be necessary for laser cutting heads, for example, where the pressure below the last protective glass can be 20 bar or more. Even low leakage rates of this seal can lead to gradual contamination of lenses and other optical elements, as the cutting gas may contain oil, water or other contaminants, or process gases may enter this area at low pressures.

At the same time, optical elements such as protective glasses or lenses should be able to be replaced by the operator without a great deal of time and effort. This replacement is usually carried out by arranging the optical elements in pull-out drawers.

Drawers that have a spring-loaded seal, at least on the side that is exposed to pressure, are known from the state of the art. The spring is usually made of stainless steel and the sealing material is PTFE or another abrasion-resistant plastic. There is often an additional sliding ring on the side facing away from the pressure to prevent direct sliding of metal on metal. If the drawer is now pushed into the holder provided, the spring-loaded seal slides over the sealing surface. To ensure this sliding, both the seal and the sealing surface must be smooth and have a certain minimum hardness. However, the required minimum hardness of the seal is an obstacle to a good sealing function or a low leakage rate.

Pressure relief valves are used, for example, to reduce a gradual increase in pressure on the optical elements above the protective glass. However, this cannot prevent gradual contamination of the optical elements above the protective glass. Instead, a constant flow of contaminated gas is generated through the optical chamber.

The use of soft seals, such as O-rings, often leads to them sticking together during operation and the drawer can no longer be pulled out.

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

The present disclosure provides a holder for an optical element which allows the optical element to be replaced quickly. Furthermore, the holder has a pressure-tight seal on one side.

Other aspects, features and advantages of the present disclosure will readily be apparent from the following detailed description, which simply illustrates preferred embodiments and implementations. The present disclosure may also be realized in other and different embodiments and its various details may be modified in various obvious aspects without departing from the teachings and scope of the present disclosure. Accordingly, the drawings and descriptions are to be considered illustrative and not limiting. Additional features and advantages of the disclosure are set forth in part in the following description and will be apparent in part from the description or may be inferred from the embodiment of the disclosure.

### BRIEF DESCRIPTION OF THE DRAWINGS

The disclosure is illustrated in more detail below with reference to the drawings. It is obvious to the person skilled in the art that these are only possible, exemplary embodiments, without the disclosure being necessarily limited to the embodiments shown, wherein:

FIG. 1 shows an exploded view of a drawer with the associated components according to an example embodiment of the disclosure.

FIG. 2 shows the elements from FIG. 1 in the assembled state with the pressure ring in a lower position according to an example embodiment of the disclosure.

FIG. 3 shows the elements from FIG. 1 in the assembled state with the pressure ring in an upper position according to an example embodiment of the disclosure.

FIG. 4 shows a sectional drawing of the arrangement of the elements of FIGS. 1-3 in a housing in a relaxed state, in which the pressure ring is in a lower position, according to an example embodiment of the disclosure.

FIG. 5. shows in a sectional drawing the arrangement of the elements from FIG. 1-3 in a housing in a locked state, in which the pressure ring is in an upper position, according to an example embodiment of the disclosure.

FIG. 6 shows a perspective view of the drawer with the lid closed according to an example embodiment of the disclosure.

FIG. 7 shows a top view of the drawer 20 with closed cover 80, which is locked in place by latch 81, such that lever 51 cannot be moved due to the closed lid, which means that pressure ring 5 is locked in relation to rotation around guide 21, according to an example embodiment of the disclosure.

FIG. 8 shows a laser processing head in which a housing with drawer is arranged as described herein according to an example embodiment of the disclosure.

### DETAILED DESCRIPTION OF THE DISCLOSURE

The present disclosure relates generally to a seal for optical elements.

For the purposes of the present disclosure, optical elements are to be understood as lenses, protective glasses, mirrors and beam shaping elements. The term fixation in connection with an optical element comprises the centering and positioning of the optical element in the beam path.

The present disclosure provides a drawer for receiving optical elements which, when inserted, can be spread open so that a seal on one side of the optical element is pressed against the sealing surface. The expansion is achieved by rotating a pressure ring along several ramps that are arranged in a circle in the drawer. Spreading in the drawer can also be achieved by other means such as wedges, threads or similar.

Accidental release of the pressure built up by the rotation is prevented by the closed cover of the drawer, as this prevents it from turning back. To pull out the drawer, the cover is opened again, the drawer is released and can now be pulled out. If the seal sticks to the sealing surface, the necessary force can be applied to the protective glass by means of a positive fit on the protective glass to release this adhesion. The necessary form fit is achieved by manufacturing the seal as a molded part from elastomers such as NBR (nitrile butadiene rubber), SBR (styrene butadiene rubber), EPDM (ethylene propylene diene; M group), FPM and FKM (fluor rubber), HNBR (hydrogenated acrylonitrile butadiene rubber).

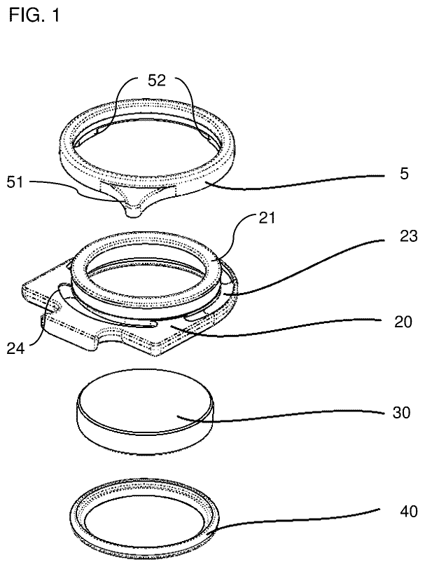

FIG. 1 shows an exploded view of a drawer with the associated components according to an example embodiment of the disclosure. Pressure ring 5 has a lever 51 on one side, which projects radially from the outer edge of pressure ring 5. Lever 51 can be used to rotate pressure ring 5 in a circle around its center. During rotation, the pressure ring is turned around the circular guide 21 of the drawer 20. On the underside, pressure ring 5 has at least one projection 52, which is arranged on the ramps 23 of drawer 20. In the embodiment shown in FIG. 1, the ramps 23 are arranged in recesses or slots 24.

The optical element 30 is arranged in the guide 21. Seal 40 surrounds the lower edge of optical element 30.

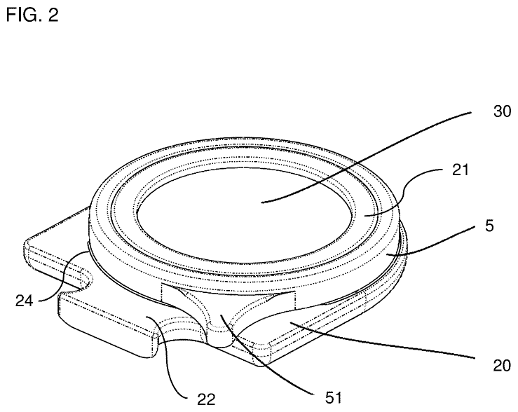

FIG. 2 shows the elements of FIG. 1 in the assembled state with the pressure ring in a lower position according to an example embodiment of the disclosure. Pressure ring 5 surrounds guide 21 of drawer 20. Optical element 30 is arranged in guide 21. The seal arranged at the lower edge of the optical element 30 is not visible in FIG. 2.

In the example embodiment shown in FIG. 2, lever 51 is arranged on the right-hand side of connecting element 22. The connecting element 22 serves to connect and fix the drawer 20 to a device in which the drawer 20 is arranged.

In FIG. 2 it can be seen that there is no gap between pressure ring 5 and drawer 20. The at least one protrusion (not visible) on the underside of pressure ring 5 is arranged in the recesses 24 at the lowest point of the at least one ramp (not visible). Pressure ring 5 is thus in a lower position.

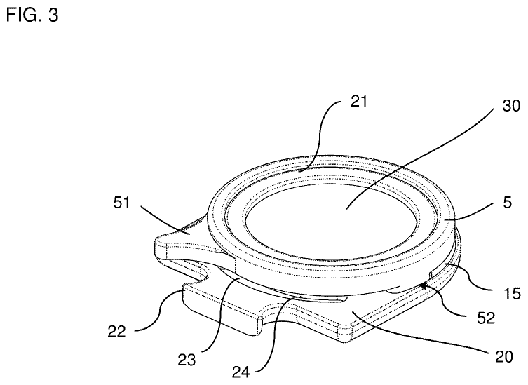

FIG. 3 shows the elements of FIG. 1 in the assembled state with the pressure ring 5 in an upper position according to an example embodiment of the disclosure. Lever 51 is located in FIG. 3 on the left side of connecting element 22. The changed position is based on a rotation of pressure ring 5 around guide 21 of drawer 20. To perform this rotation, pressure ring 5 can be moved by means of lever 51.

The at least one protrusion 52 moves in the circular recesses 24 and slides upwards on ramp 23, so that pressure ring 5 also moves or lifts upwards. Gap 15 is created between drawer 20 and pressure ring 5 by its upward movement.

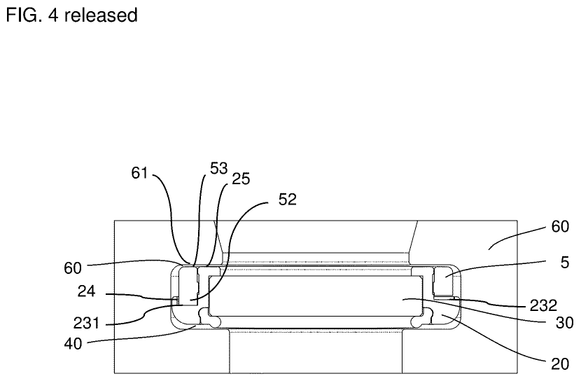

Now that the interaction between the pressure ring 5 and the drawer 20 has been described, FIG. 4 shows in a sectional drawing the arrangement of the elements from the previous figures in a housing 60 in a relaxed state, in which the pressure ring 5 is in a lower position in the drawer 20, according to an example embodiment of the disclosure.

On the left side of optical element 30, it can be seen that protrusion 52 is in contact with the lower end 231 of ramp 23 (not visible) in recess 24. Protrusion 52 is therefore at the lower end of the ramp (not visible). On the right side of optical element 30, a gap can be seen between the upper end 232 of ramp 23 (not visible) and the lower surface 54 of pressure ring 5. Protrusion 52 at the lower end of pressure ring 5 is concealed on the right-hand side.

Since in FIG. 4 the upper edge 53 of pressure ring 5 does not rise above the upper edge 25 of drawer 20, no pressure is exerted on seal 40. There is a gap between the inner upper side 61 of the housing 60 and the upper edge 53 of pressure ring 5. For this reason, the state shown in FIG. 4 is also referred to as the relaxed state.

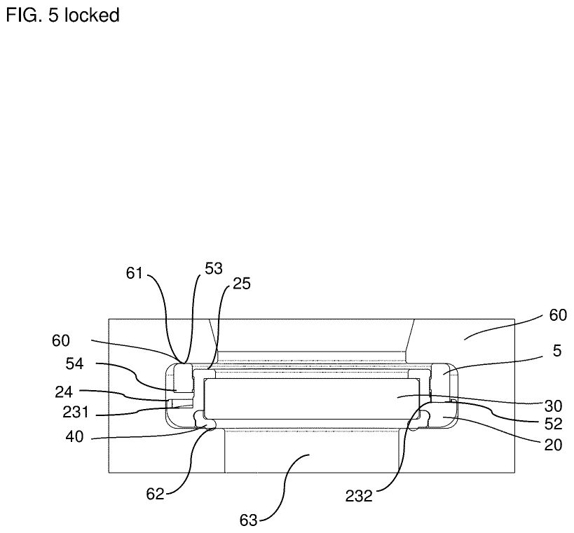

FIG. 5. shows in a sectional drawing the arrangement of the elements of FIGS. 1-3 in a housing 60 in a tensioned state, in which the pressure ring 5 is in an upper position and thus pressure is exerted on seal 40, which then ensures the sealing of the optical element 30 against the inner underside 62 of the housing 60, according to an example embodiment of the disclosure.

On the left side of optical element 30, it can be clearly seen that the upper edge 53 of pressure ring 5 rises above the upper edge 25 of drawer 25. The upper edge 53 of pressure ring 5 comes into contact with the inner upper side 61 of housing 60, whereby the drawer 20 is pressed downwards and seal 40 is squeezed between the optical element 30 and the inner lower side 62 of housing 60. This seals the lower opening 63 of housing 60.

In FIG. 5, on the left side of optical element 30, a gap can be seen between the underside 54 of pressure ring 5 and the lower end 231 of ramp 23 (not visible) in recess 24. On this side, the protrusion of the pressure ring on the ramp of the drawer has been turned upwards, as can be seen on the right side of the optical element.

FIG. 5 shows on the right side of the optical element 30 that the upper end 232 of the ramp 23 (not visible) is in contact with protrusion 52.

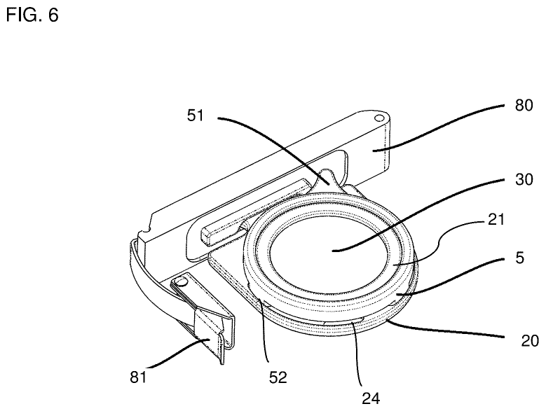

FIG. 6 shows a perspective view of the drawer 20 with closed cover 80, which is locked in place by latch 81 according to an example embodiment of the disclosure. Pressure ring 5 cannot be rotated around guide 21 by means of lever 51, as cover 80 prevents counterclockwise rotation. A further clockwise rotation is not possible, as protrusion 52 stops at the end of recess 24, at the upper end of ramp 23 (not visible). The pressure ring is therefore locked and movement in the clamped state is not possible as long as cover 80 closes the housing (not shown).

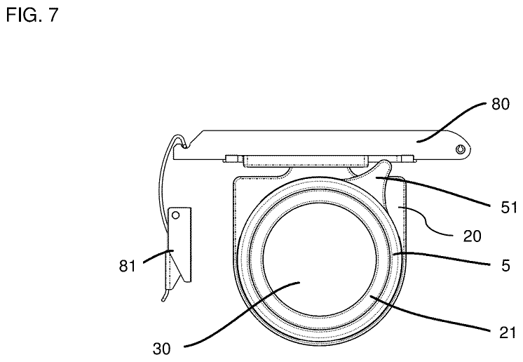

FIG. 7 shows a top view of the drawer with the lid closed and locked in place according to an example embodiment of the disclosure.

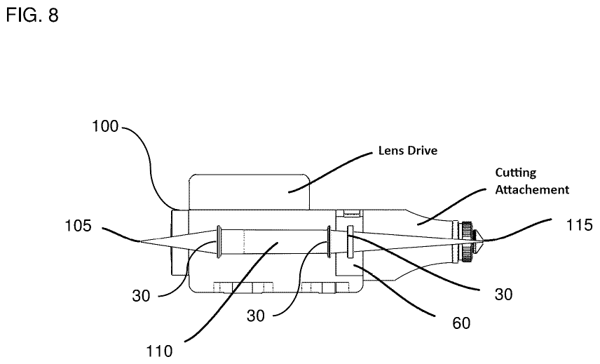

FIG. 8 shows a laser material processing head 100 in which a housing 60 with an optical element 30, as described above, is arranged, according to an example embodiment of the disclosure. On the left side, the laser beam 110 enters the laser material processing head 100 for example via a fiber 105 and is formed by further optical element 30. On the right side of laser material processing head 100, the laser spot position 115 can be seen, with which the material processing takes place. The embodiment shown in FIG. 8 also shows a lens drive 120 and cutting device 125.

The technical effect resulting from the features of the present disclosure is that a holder for an optical element can be braced in a housing with little design effort in such a way that the optical element is sealed on one side by a seal against the space behind it.

One advantage of a device according to the present disclosure is the low design effort required. In addition, it is advantageous that the tensioned pressure ring (in the upper position) in the housing is secured against being turned back into the relaxed (lower position) by the cover of the housing. The drawer can be easily removed from a laser processing head so that the optical element can be easily removed from the housing or drawer and replaced, for example. Due to the design of the holder, drawer and housing, the position of the optical element in the holder or housing is clearly defined in the device, which is why it is not necessary to check the position of the optical element or even calibrate the device (laser processing head) after changing an optical element.

The present disclosure provides a holder for an optical element, comprising a drawer having a base plate with an opening above which a seat is arranged in which an optical element is arranged, where a seal is arranged between a lower edge of the optical element and an inner lower end of the opening of the base plate of the drawer and a pressure ring is arranged around the seat, which has at least one projection on its underside which engages in at least one recess on the upper side of the base plate, and where the bottom of the at least one recess has a ramp with a seamlessly changing height in relation to an underside of the base plate.

According to the disclosure, in one embodiment it is provided that the pressure ring is arranged to rotate about the seat.

It is also provided that the pressure ring has a lever extending radially outwards.

In one embodiment of the holder, the base plate of the drawer has a connecting element on one side.

A further aspect of the disclosure relates to the holder, where the drawer with optical element, pressure ring and seal are arranged in a housing.

It is also provided that the housing has an opening above and below the optical element.

In a further embodiment of the holder, the housing has a side opening through which the drawer with optical element, pressure ring and seal can be inserted into the housing.

In one embodiment, the holder comprises a drawer that is connected to a side cover of the housing via the connecting element.

In one embodiment, the side cover of the housing of a holder and one end of the at least one recess in the base plate of the drawer fix the lever of the pressure ring in one position.

It is also provided that the side cover of the housing is fixed by a locking mechanism.

In a mount according to the present disclosure, the optical element comprises lenses, protective glasses, mirrors and beam shaping elements.

Another object of the present disclosure is a method for sealing an optical element, comprising the steps of
a. arranging of an optical element in a holder as described in this disclosure;
b. inserting of the drawer via a side opening into a housing which has an opening above and below the optical element in the inserted drawer;
c. rotating the pressure ring via a radially outwardly extending lever of the pressure ring and thus lifting the pressure ring by sliding the at least one protrusion on the underside of the pressure ring in the at least one recess on the upper side of the base plate via the ramp in the at least one recess with a seamlessly changing height;
d. bracing the pressure ring against the inside top of the housing;
e. sealing the lower opening of the housing by squeezing the seal between a lower edge of the optical element and an inner lower top of the housing.

In one embodiment, the method comprises the further step of placing the housing in a laser material processing head.

A further aspect of the present disclosure relates to a laser processing head for laser material processing comprising at least one holder as described herein or the use of a corresponding holder in a laser processing head.

Other aspects, features and advantages of the present disclosure will readily be apparent from the following detailed description, which simply illustrates preferred embodiments and implementations. The present disclosure may also be realized in other and different embodiments and its various details may be modified in various obvious aspects without departing from the teachings and scope of the present disclosure. Accordingly, the drawings and descriptions are to be considered illustrative and not limiting. Additional features and advantages of the disclosure are set forth in part in the following description and will be apparent in part from the description or may be inferred from the embodiment of the disclosure.

1. A holder for an optical element, comprising a drawer having a base plate with an opening above which a seat is arranged in which an optical element is arranged, wherein a seal is arranged between a lower edge of the optical element and an inner lower end of the opening of the base plate of the drawer and a pressure ring is arranged around the seat, which has at least one projection on its underside which engages in at least one recess on the upper side of the base plate, wherein the bottom of the at least one recess has a ramp with a seamlessly changing height in relation to an underside of the base plate.

2. The holder according to claim 1, wherein the pressure ring is arranged rotatably about the seat.

3. The holder according to claim 1, wherein the pressure ring has a lever extending radially outwards.

4. The holder according to claim 1, wherein the base plate of the drawer has a connecting element on one side.

5. The holder according to claim 1, wherein the drawer with optical element, pressure ring and seal are arranged in a housing.

6. The holder according to claim 5, wherein the housing has an opening above and below the optical element.

7. The holder according to claim 5, wherein the housing has a lateral opening via which the drawer with optical element, pressure ring and seal is inserted into the housing.

8. The holder according to claim 5, wherein the drawer is connected to a side cover of the housing via the connecting element.

9. The holder according to claim 5, wherein the side cover of the housing and one end of the at least one recess in the base plate of the drawer fix the lever of the pressure ring in one position.

10. The holder according to claim 1, wherein the side cover of the housing is fixed via a latch.

11. The mount according to claim 1, wherein the optical element is lenses, protective glasses, mirrors and beam shaping elements.

12. A method of sealing an optical element comprising:
arranging an optical element in a holder;
inserting a drawer via a side opening into a housing which has an opening above and below the optical element in the inserted drawer;
rotating a pressure ring via a radially outwardly extending lever of the pressure ring and thus lifting the pressure ring by sliding at least one protrusion on an underside of the pressure ring in at least one recess on an upper side of the base plate via a ramp in at least one recess with a seamlessly changing height;
bracing the pressure ring against an inside top of the housing;
sealing a lower opening of the housing by squeezing a seal between a lower edge of the optical element and an inner lower top of the housing.

13. The method according to claim 12, wherein the housing is arranged in a laser material processing head in a further step.

14. A laser processing head for laser material processing comprising at least one holder, the at least one holder comprising a drawer having a base plate with an opening above which a seat is arranged in which an optical element is arranged, wherein a seal is arranged between a lower edge of the optical element and an inner lower end of the opening of the base plate of the drawer and a pressure ring is arranged around the seat, which has at least one projection on its underside which engages in at least one recess on the upper side of the base plate, wherein the bottom of the at least one recess has a ramp with a seamlessly changing height in relation to an underside of the base plate.
